(19) United States
(12) Patent Application Publication
(10) Pub. No.: US 2005/0245246 A1
(43) Pub. Date: Nov. 3, 2005

(54) System and method for accessing services and/or applications and/or content on a communication network

(76) Inventors: Arne Christian Munch, Oslo (NO); Leif Sandberg, Saltsjo-Boo (SE); Lars Christian Nordvik Berg, Drammen (NO)

Correspondence Address: Thomas Schneck;Schneck & Schneck, PO Box 2 E, San Jose, CA, 95109-0005, US

(21) Appl. No.: 10/524,813

(22) PCT Filed: Aug. 20, 2003
(86) PCT No.: PCT/NO03/00287

§ 371 Date: Feb. 18, 2005

(30) Foreign Application Priority Data
Aug. 20, 2002 (NO) 20023947

(51) Int. Cl. H04M 3/00

(52) U.S. Cl. 455/418; 455/414.1

(57) ABSTRACT

A system of accessing services, applications or content using cell phones and the like on a wireless network wherein the cell phone has a web browser that digitally communicates with a network server that interprets natural language message queries by means of text and grammar recognition software, then searches for responsive services, applications and content in databases, thereby satisfying the queries, then responds to the browser with a prioritized list from which the user may select a desired service, application or content item.

### FIELD OF THE INVENTION

The present invention is related to mobile services, in particular to provide higher availability of such in a wireless network environment.

### BACKGROUND OF THE INVENTION

Cellular phones or mobile phones are no longer used for voice transmission only. They are now extended to also function as tools for providing simple services, applications and content download to the users. Examples of popular services/content being available for mobile phone users are downloading of logos and ring tones, directory assistance, positioning services, reservations etc., i.e. Mobile Internet Services.

In the case of GSM, GPRS and UMTS, the service bearers are usually SMS, MMS or WAP. All these bearers are in a category where the availability to the customers is characterized by a threshold of complexity in the user interface, and a certain degree of technical understanding is required. In addition, for almost all SMS and MMS services and applications, the user needs to have knowledge of certain codes, syntaxes and numbers to access them. This type of services needs to be advertised daily and makes the marketing very costly. Presently, the most frequent content accessed using SMS codes is logos and ring tones. However, it is not feasible or efficient to use complex syntaxes and codes for more sophisticated content.

As a consequence, the usage of different services offered by telecom operators and service providers tends to be lower than expected. The use of the services, and accompanying technological adaptation, seems to be developing at a lower growth rate for general customers, compared to the growth of the services offered.

Consequently, there is a need for a solution lowering the threshold of complexity in the user interface, making services available on the terminals to users, and presenting information to users in an interactive way, so that the customer can communicate and understand the information received. Such a solution should be adapted and addressed to the majority of subscribers utilizing the services available. The main object is to allow a majority of subscribers the ability to use more of the operators' and content providers' value added services.

### SUMMARY OF THE INVENTION

The present invention discloses a system and a method that reduces the threshold of complexity in the user interface at terminals of a mobile wireless network. In particular, the invention comprises a system for accessing services and/or applications and/or content in a communication network from a user terminal, the services and/or applications and/or content being stored in or linked to one or more databases connected to said communication network. This system includes an Interpreter module interpreting a user-entered text phase in the user's own natural language by means of a text and grammar recognition process, said module being adapted to output commands and/or inquiries executable for a Content Logic block based on the result of said text and grammar recognition process, the Content Logic being adapted to search and find services and/or applications and/or content among said services and/or applications and/or content in said one or more databases satisfying specifications defined by the commands and/or inquiries from the Interpreter module, a Priority Logic block being adapted to sort said found services and/or applications and/or content in a prioritized list according to predefined priority rules.

### BRIEF DESCRIPTION OF THE DRAWINGS

FIG. 1 is a block diagram of the system architecture of a preferred embodiment of the present invention.

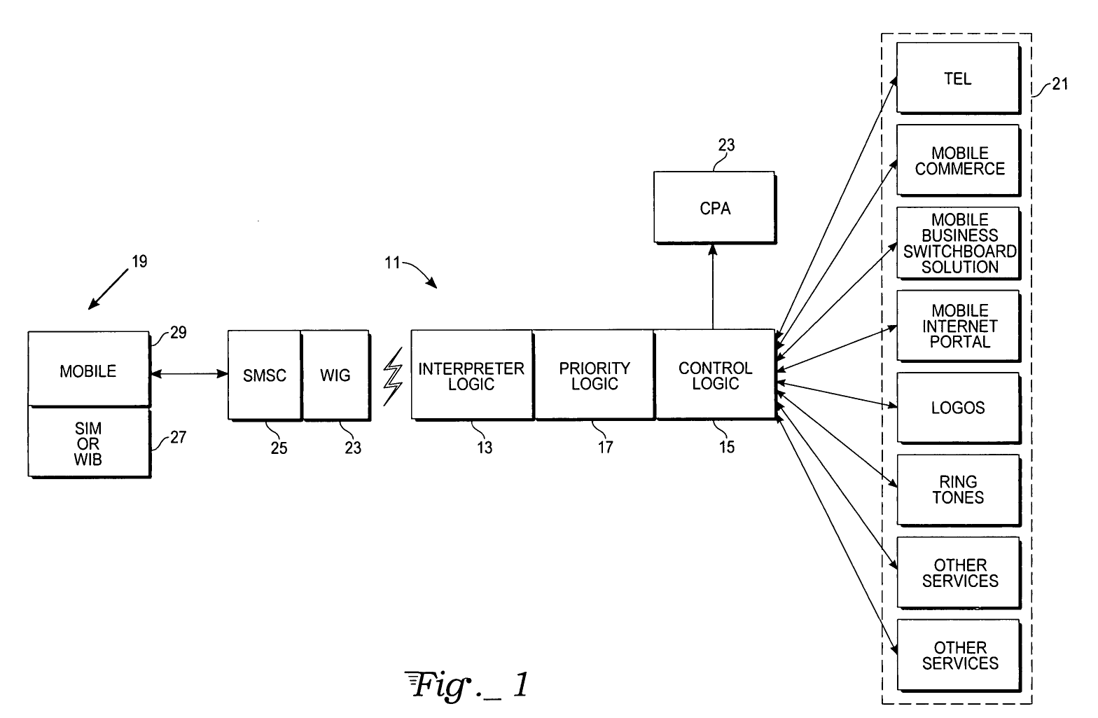

### DETAILED DESCRIPTION OF PREFERRED EMBODIMENTS

The present invention discloses a system providing existing services to wireless mobile customers in a user friendly and flexible way. From a user's point of view, a non-standardised text phrase expressing what he or she is looking for is entered into the user's terminal and the system responds with the services or content matching the message of the text phrase, possibly in a prioritized order. Alternatively, the system is accessed and controlled by the user's voice through a voice recognition module.

The system providing this user scenario is preferably implemented in a server 11 at a telecommunication operator, comprising three main components: Interpreter module 13, Content Logic block 15 and Priority Logic block 17. In addition, a browser mechanism for interfacing the system at the users 19 will be needed. In the case of cellular phones, a SIM browser is preferably used for this purpose. The server will also have to be connected to one or more databases containing services/content or links thereto.

The Interpreter

The object of the Interpreter module 13 is to enable users 19 to formulate and enter search strings as they would be expressed in natural speech, i.e. in the user's natural language and with normal grammatical composition, without knowing the correct syntax requested by each particular database. The search strings may be either written or spoken.

In other words, the Interpreter module 13 is text-recognition and grammar software recognizing and translating the user's own natural language into a language that the Content Logic block 15 understands. Text recognition is a fast developing field, and some of the existing solutions are already applicable for this purpose. A speech recognition system can be integrated to the natural language system to extend the system to perform a voice-based service. The response can also be voice synthesized in this case. A standard text recognition and grammar module has to be adjusted to the Content Logic block 15 so that it outputs commands and queries being executable by the Content Logic block 15. This gives the operator the opportunity to associate content with a logical response to a customer's requests or needs, i.e. the user may make his or her queries or requests by logical written sentences on the terminal display.

This Interpreter module could be based on standard, off-the-shelf, natural text recognition and grammar software. The text recognition and grammar software may be used as a verbal compiler. It runs on a standard operating system with an internet information server as an online resource with an SQL database server used as an information store.

The prototype verbal compiler of Interpreter module 13 is designed to be accessed by IP protocol through a slim operator-specific layer. The prototype verbal compiler can access knowledge bases in several ways, e.g. by using the http protocol, using SQL statements and by macros to internal storage. Internally, all is defined by use of XML code in the verbal compiler. Externally, the verbal compiler communicates by use of http towards technical partners or content providers 21. The format must regularly be customised for each partner.

Content Logic

The Content Logic block 15 contains a set of predefined tables, matrixes and commands as well as search engines to execute the desired queries and commands generated from the text entered by the user in addition to information and links to all active and current services and contents in block 21. This logic will be the gate to all contents and is connected to the CPA (Content Provider Access) block 23 and thus the billing system. The Content Logic block 15 will receive requests by means of queries and commands from the Interpreter block 13, informing the Content Logic block 15 what kind of services or contents to search for. The Content Logic block 15 then searches through one or more databases containing all available services or contents. The services or contents are preferably categorized in several classifications as, e.g., sports, weather, location based Content, etc. Other examples of services or content being available in the databases are dictionaries, encyclopaedias, traffic information and services, directory assistance, ring tones, logos, music, videos, voice mail, cinema, Mobile Commerce, positioning services etc.

If more than one service or content is found, it is left to a Priority logic block 17 to order the services or contents. The result of the search is then returned to the user's terminal, and by use of a SIM toolkit, the services or content found will preferably appear in the terminal display as selectable menu options. The number of hits presented to the user, either through SMS, MMS, Mobile email, Cellbroadcast, WAP, WAP push or through voice channel (synthesized), can be numerous, but is preferably limited to a certain number, with the option to see more if requested.

Priority Logic

The Priority Logic block 17 is driven by a method for prioritizing between the services or content of all the Content Providers (CP) available through the operator's network in block 21. The list is to be organised in different classifications of services fitted to be grouped together.

When the user requests a certain service or application, or asks for (general) information, the Content Logic block 15 will find the most relevant services or content and relay the list to the Priority Logic block 17. The list is then arranged in a prioritised order according to what is most likely to satisfy the user's need and/or what is most valuable for the operator. To provide this, a database containing a ranking list is integrated in the Priority Logic block 17. The list is segmented into different classifications of services and applications.

Consequently, the user may experience a set of hits as a response to a successful request, and for this to be interesting, it is a requirement that the most popular services and applications are among the hits. The user should be able to personalise the service, e.g. having the possibility to set a limit of the number of hits that is provided to him or her.

The function of the Priority Logic block 17 is for the operator to organize services/content related to the end-user's requests. This will add value to the service, as the prioritised content is the most likely wanted item requested. The motivation to implement Priority Logic block 17 is based upon the assumption that rich and solid content providers are willing to pay according to a defined structure to be present in the hit list presented to the end user.

SIM Browser

In a preferred embodiment of the invention, a SIM Browser is used by users 19 for accessing the system. A SIM browser is a standard product used by several mobile operators, and resides in a SIM card that can be used for menu-driven access to SMS based services and for enabling SIM application toolkit commands. A SIM Browser can be described as partly similar to a conventional Internet browser, such as Microsoft Internet Explorer and is termed a wireless internet browser, WIB 27.

The SIM Browser 27 receives byte coded WML-scripts from the Wireless Internet Gateway (WIG) server 23 as a message from SMSC block 25 and runs these WML-script commands as SIM Application Toolkit (SAT) commands on the Mobile unit 29. The SIM Browser is implemented as a SIM Toolkit Application and will also use SIM Application Toolkit commands, e.g., for displaying text and getting key for interaction with the user.

The SIM Browser in the context of the present invention is responsible for: providing user access to the system by means of an option in the menu; transmitting the user-entered text phrase to the Interpreter module 13; receiving a response and displaying it to the customer; carrying out the requested operation if accepted by the customer; and performing any end-to-end security functions if requested.

The combination with preloaded menu in the SIM and SIM Browser technique resembles that of wireless application protocol, or WAP, a standard for displaying web pages on cellphones, but using the SIM browser 27 gives the advantage of direct access to the system of the present invention through a menu option in the menu system of the user's terminal without being forced to set up a WAP session or SMS semi-WAP interaction to get information. In addition, the terminal does not have to be WAP configured for making use of the system. However, use of the WAP browser and setting up a WAP session in addition to the SIM browser might be favourable in certain cases, and will also be within the scope of the present invention.

User Scenario

In the following, the steps of an example user scenario of the present invention will be presented. First, the user 19 selects the menu option to access the system of the present invention, e.g. called “mGuru search”. Second, the user enters a text phrase of his choice in the SIM Toolkit menu by means of his/her keyboard, e.g. “my nearest petrol station” or “petrol station in my area” or only “petrol”. Third, the SIM sends this request to the Interpreter logic 13 through SMSC 25, or alternatively MMS, Mobile Email and OTA/WIG. Fourth, by means of the words “nearest” or “area” and “petrol station”, the Interpreter Logic 13 outputs a search command to the Content Logic 15 for positioning services. Fifth, the Content logic 15 finds a number of services and deliberates with the Priority Logic 17 before sending a WML response back to the SIM Toolkit and the user 19 including a prioritized list of the services found. Sixth, the display-text of the response is shown to the user 19 who either confirms or rejects the response or key in a new string. Seventh, this response from the SIM 27 is relayed back to the Interpreter logic 13. Eighth, upon user confirmation, the content provider 21 presents his “offer” to the user and takes over the process/dialogue. Finally, the user 19 has got his or her wanted service.

Optionally, if the user 19 has predetermined that the system should respond with only one service per request, the sixth through ninth steps may be replaced by one single step of presenting the result of the service being on top of the priority list directly to the user. The user would then experience the response of his or her request, e.g. as a map sheet appearing on his or her display, plotting the exact route from his or her current position to the nearest petrol station.

### Another Example

The user selects the menu option to access the system as in step 1 above. The user 19 enters “The last melody of Eminem”. This request is sent to the Interpreter logic 13 which outputs a search command to the Content Logic 15. The Content logic 15 finds a number of services and deliberates with the Priority Logic 17 before sending a WML response, or WAP push message back to the user including a prioritized list of the services found: a) “Listen to the last studio version”; b) “Provide as ringing tune”; c) “Provide as logo”; d) “MMS picture gallery”; e) “Order CD”; f) “Order DVD from provider A, USD 29.95”; g) “Order DVD from provider B, USD 37.95”; h) “Book movie ticket”; i) “Information from fan club”. The user 19 chooses one option from the list, whereupon the content provider 21 presents his “offer” to the user and takes over the process/dialogue of the transaction.

The various options presented to the user relates to different applications with widely different interfaces. However, the user will only see a “standard” interface common for all the applications, and which is simple in use for an occasional user. In this way the “mechanics” behind the interface is completely hidden from the user.

The main advantage of the present invention is that it minimizes the threshold complexity in the user interface of services and content provided for cellular phones, and makes it very simple for the user to find wanted services, information or products. The present invention will let the user browse and find new or already known service, information or product possibilities without having to know certain SMS codes, search techniques and/or telephone numbers.

Besides, the present invention will reduce the costs for advertising of SMS codes, reduce integration cost for Content providers, and will probably multiply the sales of different contents.

The invention has been described as applicable in the contexts of traditional mobile networks like GSM, GPRS, UMTS, etc. However, as communication technologies are evolving, the invention can find application here as well. As examples of other technologies of interest, WLAN, HiperLAN, Bluetooth and InfraRed (JR) communication networks could be used. This list of currently available communication technologies must not be considered as exhaustive; in the future other technologies will certainly become available, and which can be supported by the system and method of the present invention.

While the invention has been described in the context of mobile services, it can find application in a stationary environment as well. A Web server with the three modules mentioned above installed, can be accessed from a standard Web browser in a desktop Personal Computer. In this way the same benefits of a uniform access interface to a multitude of different services or applications or information contents can be achieved. This solution will in principle be almost identical to the mobile approach, except for billing solutions, even though a full fledged web browser is used. The additional capabilities of such a web browser may of course be exploited with advantage to add features in the user interface.

1. A system for accessing services, applications and content in a communication network from a user terminal, the services, applications and content being stored in or linked to one or more databases connected to said communication network, comprising:
an Interpreter module means connected to receive a user-entered text phrase in the user's own natural language by means of a text and grammar recognition process, said module for outputting commands and inquiries;
a Content Logic means receiving said commands and inquiries for searching and finding services, applications and content among said services, applications and content in said one or more databases satisfying specifications defined by the commands and inquiries from the Interpreter module means, and
a Priority Logic means for sorting said found services, applications and content in a prioritized list according to predefined priority rules.

2. A system as claimed in claim 1, further comprising a set of tables in the Content Logic means associating possible incoming commands and inquiries with search strings for search engines to operate in said one or more databases with links to services, applications and content in said one or more databases.

3. A system as claimed in claim 1 wherein the Priority Logic means includes a ranking list prioritizing at least some of the available services, applications and content that is being used in said sorting of the services, applications and content in the prioritized list.

4. A system as claimed in claim 1 wherein the Priority Logic means for sorting includes means for sorting according to what is most likely to match a user's need expressed in the commands and inquiries resulting from the user-entered text phrase input in the Interpreter module means.

5. A system as claimed in claim 1 further comprising:
providing user terminal means having a browser means for user access to the system by means of an option in the user terminals in which the text phrase is entered, for transmitting the user-entered text phrase to the Interpreter module, for receiving said prioritized list and for displaying at least a part of this as selectable service, application and content, and
for carrying out operations of a user selected service, application and content.

6. A system as claimed in claim 5 wherein said browser is a SIM or WAP browser.

7. A system as claimed in claim 1 wherein the Interpreter module means, the Content Logic means and the Priority Logic means reside in a server associated with the communication network, and wherein the server is connected to a billing mechanism charging users for each use of the system.

8. A system as claimed in claim 1 wherein the communication network is a GSM, GSM/GPRS or a UMTS network and that the user terminals are cellular phones.

9. A system as claimed in claim 1 wherein a Speech Recognition Module is integrated in the Interpreter Module providing voice based user access and control to/of the system.

10. A method for accessing services, applications and content in a communication network from a user terminal, the services, applications and content being stored in or linked to one or more databases connected to said communication network, comprising:
interpreting a user-entered text phrase in a user's own natural language by means of a text and grammar recognition process, providing search commands and inquiries based on the result of said text and grammar recognition process,
searching services, applications and content among said services, applications and content in said one or more databases satisfying specifications defined by said commands and inquiries, and
sorting said found services, applications and content in a prioritized list according to predefined priority rules.
